(19) United States
(12) Patent Application Publication
(10) Pub. No.: US 2013/0254767 A1
(43) Pub. Date: Sep. 26, 2013

(54) COMPUTER AND BANDWIDTH CONTROL METHOD

(71) Applicant: HITACHI, LTD., Tokyo (JP)

(72) Inventors: Kazuhiko Mizuno, Hachioji (JP); Takayuki Imada, Yokohama (JP); Naoya Hattori, Yokohama (JP); Yuji Tsushima, Hachioji (JP)

(73) Assignee: Hitachi, Ltd., Tokyo (JP)

(21) Appl. No.: 13/760,717

(22) Filed: Feb. 6, 2013

(30) Foreign Application Priority Data
Mar. 22, 2012 (JP) 2012-065648

(51) Int. Cl. G06F 9/455

(52) U.S. Cl. CPC G06F 9/455
USPC 718/1

(57) ABSTRACT

A computer with a processor, memory, and one or more network interfaces, the computer having a virtualization management unit for managing a virtual computer and a bandwidth control unit for controlling a bandwidth in use in a virtual computer group comprised of one or more virtual computers, in which the virtualization management unit contains an analysis unit for managing a bandwidth in use of virtual network interfaces allocated to the virtual computers, the analysis unit measures the bandwidth in use of the each virtual computer, determines whether there exists a first virtual computer group whose bandwidth in use is smaller than a guaranteed bandwidth, and commands to control the bandwidth of a second virtual computer group whose bandwidth in use is larger than the guaranteed bandwidth, and the bandwidth control unit secures a free bandwidth just equal to a shortage of the guaranteed bandwidth of the first virtual computer group.

### CLAIM OF PRIORITY

The present application claims priority from Japanese patent application JP 2012-065648 filed on Mar. 22, 2012, the content of which is hereby incorporated by reference into this application.

### FIELD OF THE INVENTION

The present invention relates to a bandwidth control technology of a network in a computer system in which a virtual computer operates.

### BACKGROUND OF THE INVENTION

A server virtualization technology of dividing and using a computer resource of a physical server has come into its diffusion period, and a hardware assist function by the physical server is also being enriched.

The physical server has a CPU and an I/O device as the computer resource, and regarding the CPU, a hardware assist function, such as VT-x of Intel Inc. (Intel is a registered trademark, hereafter the same), has already been used widely. On the other hand, regarding the I/O device, an overhead of virtualization poses a problem. Especially, an NIC (Network Interface Card) is being enlarged in the bandwidth rapidly, and an overhead for sharing the NIC has been expanded.

The above-described occurrence of the overhead has caused a problem that a throughput of CPU that is the computer resource inside the physical server is wasted and a problem that a wide bandwidth that is an essential use of the NIC cannot be used. Moreover, there also arises a problem that when a specific virtual machine or a virtual machine group (VM Group) in which multiple virtual machines are grouped transmits and receives a large amount of data, a bandwidth in use of other VMS and VM Groups cannot be guaranteed.

As a technology to guarantee a bandwidth of a network, there is proposed a technology whereby a function of a WRR (Weighted Round Robin) system added with a control of an upper limit and a lower limit of the bandwidth in use is installed in the NIC, and the bandwidth in use of the VM is guaranteed by controlling the bandwidth between a virtual NIC (VNIC) on the VM side and the NIC on a physical server side (e.g., refer to Japanese Unexamined Patent Application Publication No. 2009-239374). Here, the WRR system is a control system of setting up a precedence of the VM and changing the VM that has a right to use the bandwidth in a time division manner.

Moreover, PCI-SIG (Peripheral Component Interconnect Special Interest Group) that is a business group for settling on PCI standards and the like, as an I/O device virtualization support facility by hardware, is standardizing SR-IOV (Single Root I/O Virtualization) that supports virtualization on a PCI device side. In the SR-IOV, the PCI device provides multiple virtual I/O devices (VFs: Virtual Functions), and the PCI device can be shared among the VMs by allocating the VF to the VM exclusively. Moreover, in order to prevent a certain VM from monopolizing and using a bandwidth, as a de facto standard of the SR-IOV, the SR-IOV is provided with a function of setting an upper limit of a transmission bandwidth for every VF.

Moreover, as a technology of implementing a network bandwidth control as software, Nexus 1000V of Cisco Systems, Inc. (Cisco is a registered trademark, hereafter the same) provides a LAN switch as software in association with VMware vSphere (VMware vSphere is a registered trademark, hereafter the same) of VMware Inc. (VMware is a registered trademark, hereafter the same) (e.g., refer to “Cisco Nexus 1000V Series Switches,” Data Sheet, 2011).

Specifically, by a VMware ESX kernel or a VEM (Virtual Ethernet Module) mounted as a part of the VMware ESXi kernel operating in place of a VMware Virtual Switch function and by a VSM (Virtual Supervisor Module) implemented on a physical server as software controlling the VEM, the bandwidth in use is dynamically adjusted between the VM and the NIC of the physical server.

Furthermore, as a standard of an external switch about the network bandwidth control, a PFC (Precedence-based Flow Control) function and an ETS (Enhanced Transmission Control) function have been standardized in the CEE (Converged Enhanced Ethernet) that is a standard of the extended Ethernet (Ethernet is a registered trademark, hereafter the same).

The PFC function is a function of dividing traffic with a priority added thereon in order to prevent the bandwidth from being used excessively, and when the divided traffic enters into a congestion state, temporarily suspending data transmission by transmitting a PAUSE frame and thereby resolving frame disappearance by the congestion. The ETS function is a function that allocates the priority-added traffic to a group and performs the bandwidth control of each group by WRR. By these PFC function and ETS function, the bandwidth in use can be guaranteed between CEE switches.

### SUMMARY OF THE INVENTION

When like a technology described in Japanese Unexamined Patent Application Publication No. 2009-239374, an NIC of a physical server implements a bandwidth control function, a wide bandwidth and bandwidth guarantee can be realized without wasting a CPU that is a computer resource of a physical server.

However, it is necessary to perform a predetermined setting on the NIC, and only individual bandwidth guarantee can be performed in the invention described by Japanese Unexamined Patent Application Publication No. 2009-239374. Therefore, in an environment where multiple VMs are used for the same business, the bandwidth guarantee to the business cannot be provided. Since there is a limit in the number of VMs used in the business even when the implementation of the NIC is changed in order to perform the bandwidth guarantee of multiple VMs, it will be used only for a limited computer system.

When SR-IOV of PCI-SIG is used, since an upper limit of a transmission bandwidth can be set up for every VF, realization of a wide bandwidth is possible.

However, since a bandwidth control to a PCI device that multiple VMs share and use cannot be performed in such a way as to adapt to a use situation between VMs that share it, the bandwidth guarantee between the VMs that share it cannot be performed.

When a network bandwidth control is implemented as software, since the same function as Nexus 1000V is implemented and a function of presenting an external switch can be used, the bandwidth guarantee of the VM can be realized.

However, since emulation is performed using the CPU of the physical server, waste of the CPU that is the computer resource of the physical server becomes large and realization of a wide bandwidth of 10 Gbps etc. is difficult.

In the case of the bandwidth control by the external switch using a PFC function and an ETS function of the CEE, there is no waste of the CPU that is the computer resource of the physical server and the bandwidth can be guaranteed even if it is a wide bandwidth.

However, since the external switch cannot grasp a bandwidth in use of an individual VM and the bandwidth is controlled only to the NIC existing on a route from the VM to the external switch, it is impossible to perform the bandwidth guarantee of the individual VM that accesses the NIC and the bandwidth guarantee between multiple VM.

As in the above, when the bandwidth control function implemented in hardware is used, although a wide bandwidth and bandwidth guarantee can be realized without wasting the CPU, it becomes necessary to perform implementation that is matched with the VM, and a special NIC becomes needed. On the other hand, when the bandwidth control function implemented in software is used, since the CPU is wasted, it is difficult to realize a wide bandwidth.

Moreover, when the SR-IOV or the external switch of the CEE is used, since the bandwidth control matched to the use situation between the VMs in a state where the whole maximum bandwidth of the NIC is used cannot be performed, there is a problem that the bandwidth guarantee between the VMs cannot be realized.

An object of the present invention is an invention performed in view of the above-described problem. That is, it is to secure a wide bandwidth without wasting a CPU resource of the physical server, to realize the bandwidth guarantee to the VM and the VM Group, and further to secure flexibility that does not depend on a specific hardware configuration.

If one example of a representative aspect of the invention disclosed in this application is shown, it will be as follows. That is, it is a computer that has a processor, memory connected to the processor, and one or more network interfaces for communicating with an other device, the computer having a virtualization management unit that divides the resource of the computer to generates one or more virtual machines and manages the generated virtual machines and a bandwidth control unit for controlling the bandwidth in use in a virtual computer group comprised of the one or more virtual computers, in which the virtualization management unit contains an analysis unit for managing the virtual network interfaces allocated to the virtual computers, in which when the bandwidth in use of the network interface is identical to a maximum bandwidth that is an upper limit of the bandwidth in use of the network interface, the analysis unit holds a guaranteed bandwidth information for managing a guaranteed bandwidth that is a bandwidth that should be secured in the virtual computer group, in which the analysis unit measures the bandwidth in use of the each virtual computer, retrieves a first network interface whose bandwidth in use is identical to the maximum bandwidth of the interface, determines whether there exists a first virtual computer group whose bandwidth in use is smaller than the guaranteed bandwidth set in the virtual computer group among the virtual computer groups to each of which a resource of the first network interface is allocated based on the measurement result and by referring to the guaranteed bandwidth information, and when it is determined that the first virtual computer group exists, retrieves a second virtual computer group whose bandwidth in use is larger than the guaranteed bandwidth set in the virtual computer group among the virtual computer groups to each of which the resource of the first network interface is allocated based on the measurement result and by referring to the guaranteed bandwidth information and commands the bandwidth control unit to control the bandwidth of the second virtual computer group, and in which the bandwidth control unit secures a free bandwidth just equal to a shortage of the guaranteed bandwidth of the first virtual computer group by controlling the bandwidth of the retrieved second virtual computer group.

According to the present invention, the bandwidth in use between the virtual computer groups is grasped, and the bandwidth guarantee to a virtual machine group can be realized. Moreover, since the bandwidth control unit controls the bandwidth of each virtual computer group, it is possible to realize a wide bandwidth without wasting the resource of the processor.

### BRIEF DESCRIPTION OF THE DRAWINGS

FIG. 1 is an explanatory drawing showing one example of a computer system in a first embodiment of the present invention;

FIG. 2 is a block diagram explaining details of a configuration of a physical server in the first embodiment of the present invention;

FIG. 3 is an explanatory drawing showing one example of a storage area of memory in the first embodiment of the present invention;

FIG. 4 is an explanatory drawing showing one example of an adapter allocation table in the first embodiment of the present invention;

FIG. 5 is an explanatory drawing showing one example of a capping table in the first embodiment of the present invention;

FIG. 6 is an explanatory drawing showing one example of a QoS group table in the first embodiment of the present invention;

FIG. 7 is an explanatory drawing showing one example of a capacity table in the first embodiment of the present invention;

FIG. 8 is a flowchart explaining a processing that a hypervisor in the first embodiment of the present invention performs at the time of starting;

FIGS. 9A and 9B are explanatory drawings showing an outline of a bandwidth control processing that a throughput analysis unit in the first embodiment of the present invention performs;

FIG. 10A is a flowchart explaining details of the bandwidth control processing in the first embodiment of the present invention;

FIG. 10B is a flowchart explaining details of the bandwidth control processing in the first embodiment of the present invention;

FIG. 11 is a flowchart explaining a processing that a capping function in the first embodiment of the present invention performs when receiving a command to update a capping value;

FIG. 12 is a flowchart explaining a modification of the bandwidth control processing in the first embodiment of the present invention;

FIG. 13 is a block diagram explaining details of a configuration of a physical server in a second embodiment of the present invention;

FIG. 14 is an explanatory drawing showing an example of a position of a storage area of memory in the second embodiment of the present invention;

FIG. 15 is an explanatory drawing showing one example of a capping table in the second embodiment of the present invention;

FIG. 16A is a flowchart explaining details of a bandwidth control processing in the second embodiment of the present invention;

FIG. 16B is a flowchart explaining details of the bandwidth control processing in the second embodiment of the present invention;

FIG. 17 is a block diagram explaining details of a configuration of a physical server in a third embodiment of the present invention;

FIG. 18 is an explanatory drawing showing one example of a storage area of memory in the third embodiment of the present invention;

FIG. 19A is a flowchart explaining details of a bandwidth control processing in the third embodiment of the present invention; and

FIG. 19B is a flowchart explaining details of the bandwidth control processing in the third embodiment of the present invention.

### DETAILED DESCRIPTION OF THE PREFERRED EMBODIMENTS

Hereafter, embodiments will be explained using drawings.

### First Embodiment

In a first embodiment, a physical server for performing a bandwidth control of a network of a virtual machine will be explained as an example.

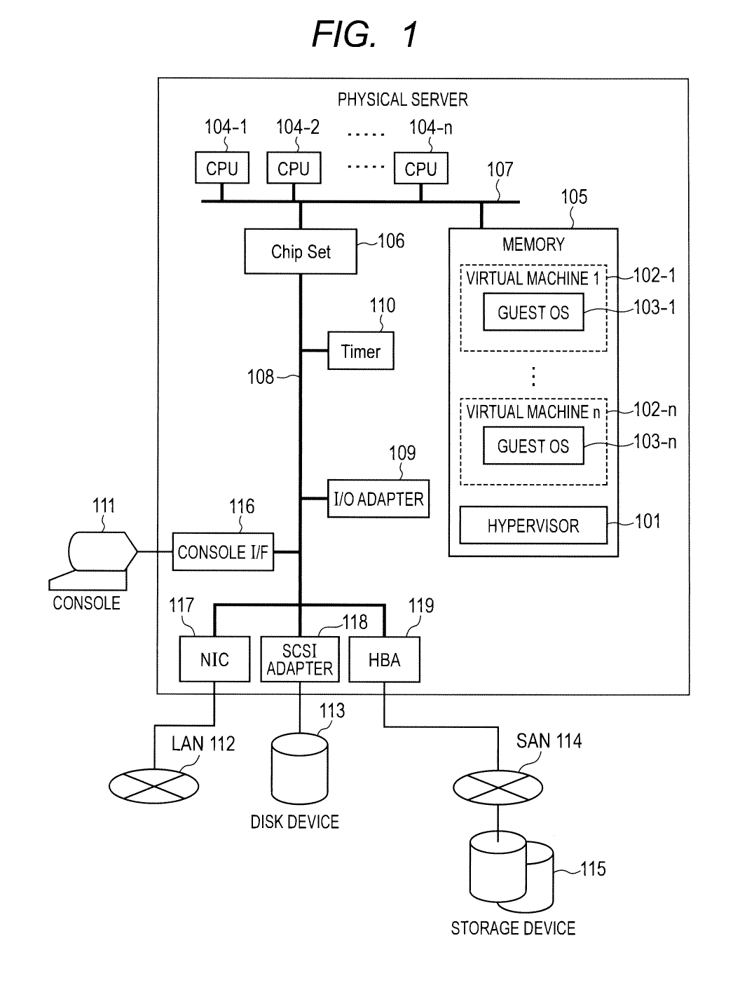

FIG. 1 is an explanatory drawing showing one example of a computer system in the first embodiment of the present invention.

A computer system is comprised of one or more physical servers 100. In this embodiment, only one physical server 100 is illustrated for simplicity of explanation.

A physical server 100 has multiple CPUs 104-1 to 104-n, These CPUs 104-1 to 104-n are connected to a Chip Set 106 through an interconnect 107, such as QPI (QuickPath Interconnect) or SMI (Scalable Memory Interconnect). In the following explanation, when the CPUs 104-1 to 104-n are not distinguished, it is described as the CPU 104.

The Chip Set 106 connects with an I/O adapter 109, a Timer 110, an NIC 117, a SCSI adapter 118, an HBA (Host Bus Adapter) 119, and a console interface (console I/F) 116 through a bus 108 such as of PCI Express.

Here, the NIC 117 is an interface for connecting with the LAN 112, the HBA is an interface for connecting with a SAN (Storage Area Network) 114, and a console interface 116 is an interface for connecting with a console 111.

The CPU 104 accesses memory 105 through the interconnect 107 and performs a predetermined processing by accessing the NIC 117 etc. through the Chip Set 106.

The memory 105 stores a program executed by the CPU 104 and information required for execution of the program. Specifically, a program that realizes a hypervisor 101 is stored in the memory 105.

The CPU 104 can realize a function that the hypervisor 101 has by loading a program that realizes the hypervisor 101 on the memory 105 and executing the program. The hypervisor 101 generates and manages one or more virtual machines 102. A guest OS 103 operates on the virtual machine 102.

Next, a principal part of a software configuration that realizes the virtual machine 102 on the physical server 100 and hardware that becomes an object of control will be explained.

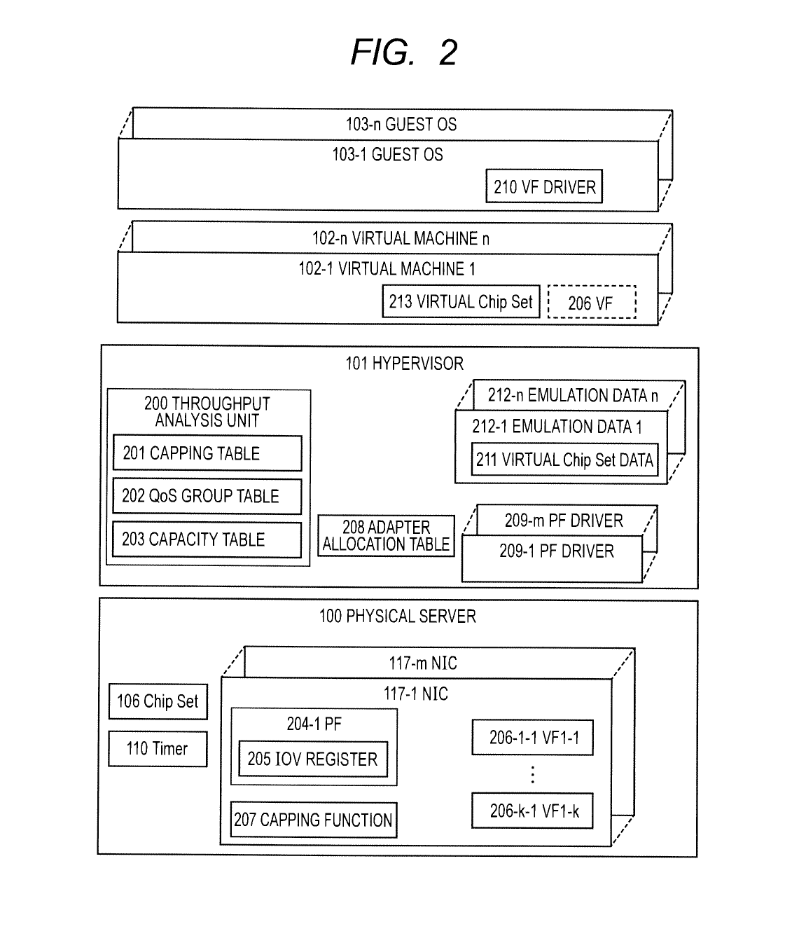

FIG. 2 is a block diagram explaining details of a configuration of the physical server 100 in the first embodiment of the present invention.

The physical server 100 has one or more NICs 117-1 to 117-m. Moreover, each of the NICs 117-1 to 117-m has an IOV function. Here, the IOV function is comprised of a physical function (PF: Physical Function) 204, a virtual function (VF: Virtual Function) 206, and a capping function 207.

A PF 204 provides a function by which the physical server 100 to transmits/receives data to/from an external network, and includes an IOV register 205 for controlling the IOV function. A VF 206 is generated by the PF 204, and provides a function of only when the IOV function is valid, enabling the physical server 100 to transmit/receive the data to/from the external network. The capping function 207 provides a function of when the physical server 100 transmits/receives the data to/from the external network, controlling an upper limit of a bandwidth in use.

Incidentally, although the PF 204 is a function that can be used always, the VF 206 is a function that can be used only when the IOV function is valid. Moreover, the physical server 100 may also contain the NIC 117 that have no IOV function.

On the physical server 100, the hypervisor 101 for controlling the virtual machine 102 operates.

The hypervisor 101 generates one or more virtual machines 102 and provides a function (a virtual Chip Set 213) that is equivalent to the Chip Set 106 to the generated virtual machines 102. Moreover, the hypervisor 101 has a function (pass-through function) of allocating exclusively an arbitrary VF 206 to an arbitrary virtual machine 102 and permitting the guest OS 103 that operates on the virtual machine 102 to directly operate the VF 206.

Moreover, the hypervisor 101 has a throughput analysis unit 200, an adapter allocation table 208, PF drivers 209-1 to 209-m, and emulation data 212-1 to 212-n.

The throughput analysis unit 200 monitors the bandwidth in use of the virtual machine 102 etc., and controls the bandwidth according to a use situation. Moreover, the throughput analysis unit 200 includes a capping table 201, a QoS group table 202, and a capacity table 203.

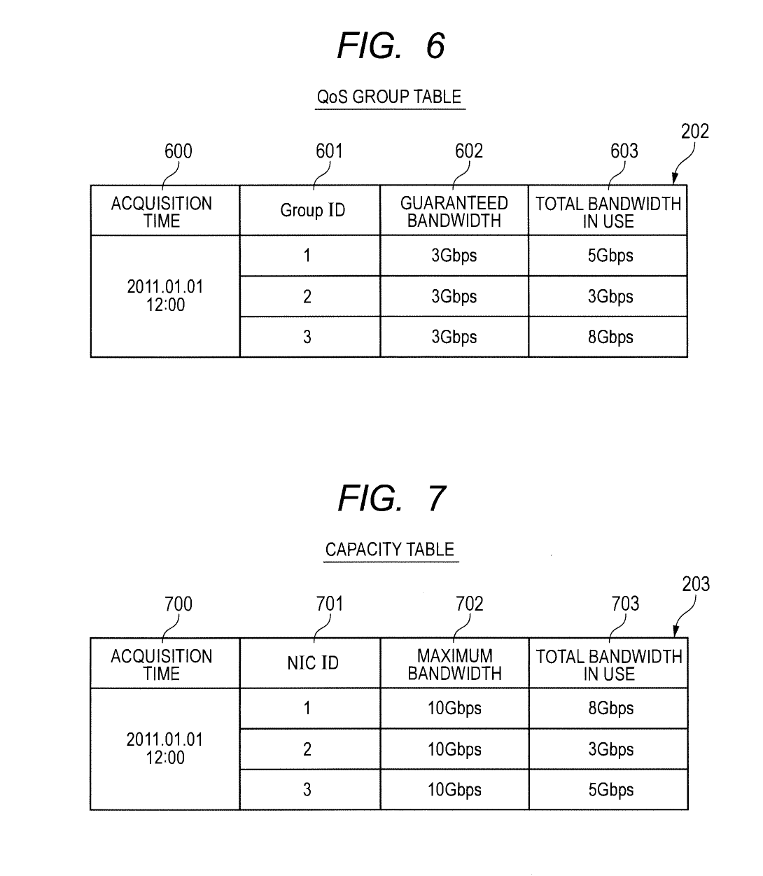

The capping table 201 stores information of the bandwidth in use and a maximum value of the bandwidth in use of each virtual machine 102, etc. Details of the capping table 201 will be described later using FIG. 5. The QoS group table 202 stores information about the guaranteed bandwidth of a virtual machine group (VM Group) comprised of the multiple virtual machines 102. Details of the QoS group table 202 will be described later using FIG. 6. The capacity table 203 stores information about a maximum bandwidth of the NIC 117. Details of the capacity table 203 will be described later using FIG. 7.

Incidentally, the throughput analysis unit 200 may combine the capping table 201, the QoS group table 202, and the capacity table 203 into one or two tables and hold them.

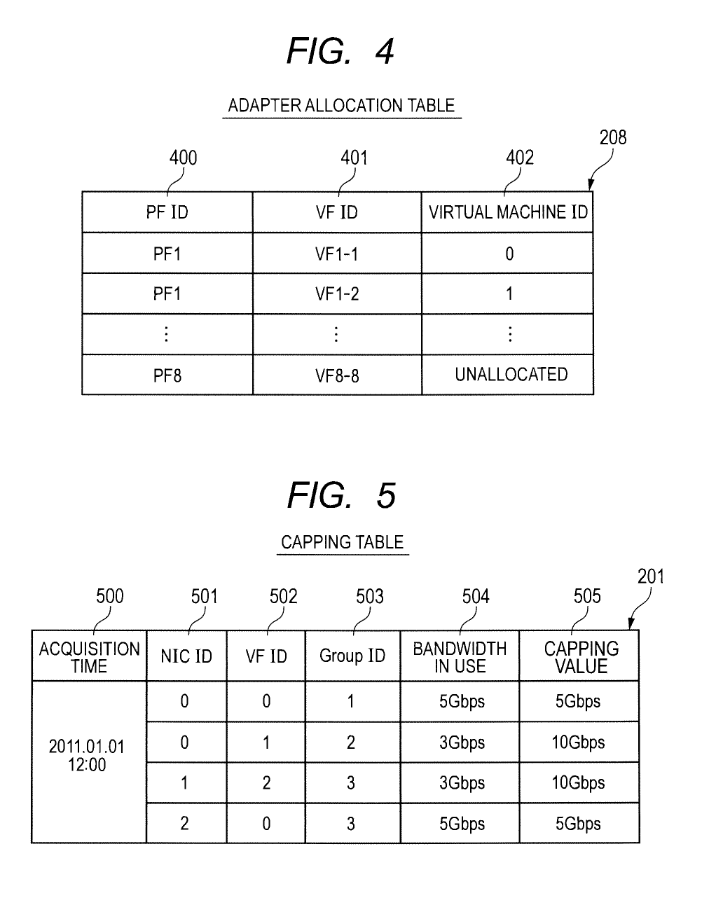

The adapter allocation table 208 stores the correspondence relation of the virtual machine 102 and the VF 206 allocated to the virtual machine 102. Details of the adapter allocation table 208 will be described later using FIG. 4.

The emulation data 212-1 to 212-n are data each holding an operating state of each of the virtual machines 102-1 to 102-n. In the following explanation, when the emulation data 212-1 to 212-n are not distinguished, it will be described as the emulation data 212.

The emulation data 212 contains virtual Chip Set data 211 that holds a state of the virtual Chip Set 213 to be provided to the virtual machine 102. Specifically, virtual Chip Set data 211 holds a state of a register etc. in the virtual Chip Set 213.

A PF driver 209 is a driver for controlling the PF 204-1 to the PF 204-m that respective NICs 117-1 to 117-m have, and has a function of operating the IOV register 205 in each of the PF 204-1 to PF 204-m.

The virtual machine 102 includes virtual parts provided by the hypervisor 101, such as the virtual Chip Set 213, and the VF 206 that was allocated exclusively. The guest OS 103 operates on the virtual machine 102. The guest OS 103 operates the VF 206 using a VF driver 210 according to the kind of the VF 206.

In this embodiment, the throughput analysis unit 200 analyzes the use situation of the network based on information of each table, and issues a command to increase/decrease the maximum value of the bandwidth in use (capping value) to be allocated to the virtual machine 102 to the capping function 207. That is, the throughput analysis unit 200 controls the bandwidth by changing the capping value.

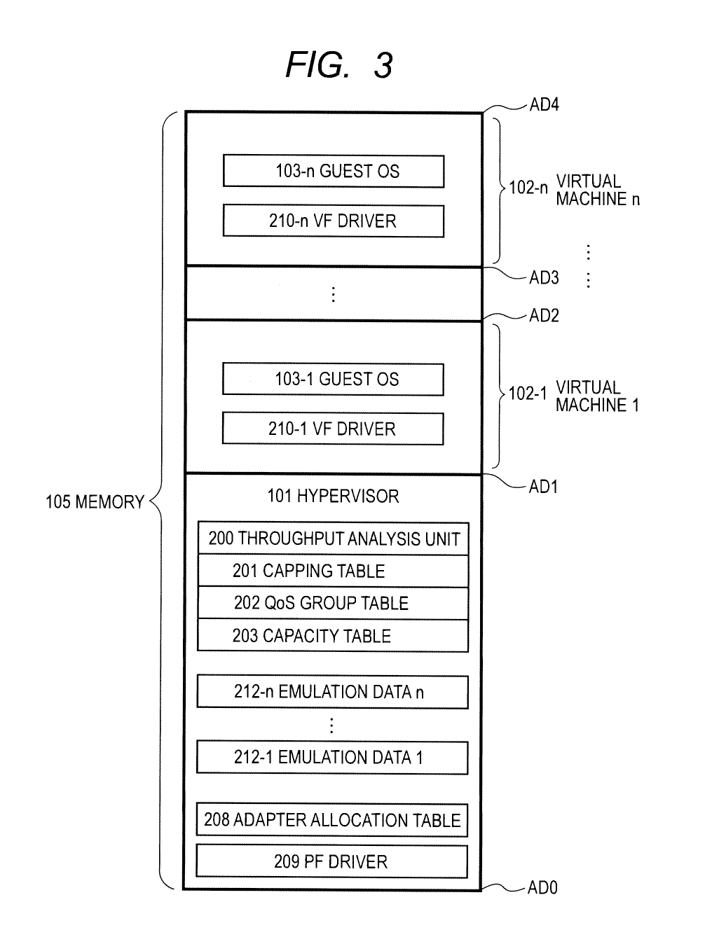

FIG. 3 is an explanatory drawing showing one example of a storage area of the memory 105 in the first embodiment of the present invention.

The hypervisor 101 is managing allocation of the storage area of the memory 105, and allocates an area that the hypervisor 101 itself uses and an area that the virtual machine 102 uses on the memory 105.

For example, as shown in FIG. 3, the hypervisor 101 allocates a storage area of a range of addresses AD0 to AD1 to the hypervisor 101 itself, allocates a storage area of a range of addresses AD1 to AD2 to the virtual machine 102-1, and allocates a storage area of a range of addresses AD3 to AD4 to the virtual machine 102-n.

In the storage area allocated to each virtual machine 102, the guest OS 103 and the VF driver 210 are stored. In the storage area allocated to the hypervisor 101, the adapter allocation table 208, the emulation data 212, the PF driver 209, the throughput analysis unit 200, the capping table 201, the QoS group table 202, and the capacity table 203 are stored.

FIG. 4 is an explanatory drawing showing one example of the adapter allocation table 208 in the first embodiment of the present invention.

The adapter allocation table 208 stores a correspondence relation between the VF 206 and the virtual machine 102. Specifically, the adapter allocation table 208 contains a PF ID 400, a VF ID 401, and a virtual machine ID 402.

The PF ID 400 stores an identifier of the PF 204 that generated the VF 206. The VF ID 401 stores an identifier of the VF 206. A Virtual machine ID 402 stores an identifier of the virtual machine 102 that is allocated to the VF 206 corresponding to the VF ID 401. Incidentally, “unallocated” is stored in the virtual machine ID 402 when the VF 206 is not allocated.

It can be grasped by the adapter allocation table 208 which NIC 117 presents the VF 206 that is allocated to a certain virtual machine 102.

FIG. 5 is an explanatory drawing showing one example of the capping table 201 in the first embodiment of the present invention.

The capping table 201 stores the capping value set in the VF 206 and information about a current bandwidth in use. Specifically, the capping table 201 contains an acquisition time 500, an NIC ID 501, a VF ID 502, a Group ID 503, a bandwidth in use 504, and a capping value 505.

The acquisition time 500 stores a time when the hypervisor 101 acquires a variety of information. NIC ID 501 stores an identifier of the NIC 117. The VF ID 502 is identical to the VF ID 401. The Group ID 503 stores an identifier of the virtual machine group comprised of the multiple virtual machines 102.

The bandwidth in use 504 stores the bandwidth in use that is currently used by the virtual machine 102 to which the VF 206 corresponding to the VF ID 502 is allocated. The capping value 505 stores the maximum value of the bandwidth in use (capping value) set to the virtual machine 102 to which the VF 206 corresponding to VF ID 502 is allocated.

FIG. 6 is an explanatory drawing showing one example of the QoS group table 202 in the first embodiment of the present invention.

The QoS group table 202 stores pieces of information, such as the guaranteed bandwidth set to the virtual machine group, and a total value of the bandwidths in use of the virtual machines 102 included in the virtual machine group. Specifically, the QoS group table 202 contains an acquisition time 600, a Group ID 601, a guaranteed bandwidth 602, and a total bandwidth in use 603.

The acquisition time 600 stores a time when the hypervisor 101 acquires a variety of information. A Group ID 601 is identical to the Group ID 503. The guaranteed bandwidth 602 stores the guaranteed bandwidth set up to the virtual machine group corresponding to the Group ID 601. The total bandwidth in use 603 stores the total value of the bandwidths in use of all the virtual machines 102 included in the virtual machine group.

Incidentally, in this embodiment, the guaranteed bandwidth indicates a bandwidth that is at least guaranteed to the virtual machine group that uses the resource of the NIC 117 when the bandwidth in use of the NIC 117 becomes identical to the maximum bandwidth.

FIG. 7 is an explanatory drawing showing one example of the capacity table 203 in the first embodiment of the present invention.

The capacity table 203 stores information about the maximum bandwidth of the NIC 117 and the total value of the bandwidths used by the virtual machines 102. Specifically, the capacity table 203 contains an acquisition time 700, an NIC ID 701, a maximum bandwidth 702, and a total bandwidth in use 703.

The acquisition time 700 stores a time when the hypervisor 101 acquires a variety of information. The NIC ID 701 is identical to the NIC ID 501. The maximum bandwidth 702 stores the maximum bandwidth of the NIC 117 corresponding to the NIC ID 701. The total bandwidth in use 703 stores the total value of the bandwidths in use of the virtual machines 102 that use the NIC 117 corresponding to the NIC ID 701.

The hypervisor 101 can monitor the use situation of the network by comparing the maximum bandwidth 702 and the total bandwidth in use 703.

Next, a processing that the hypervisor 101 performs will be explained.

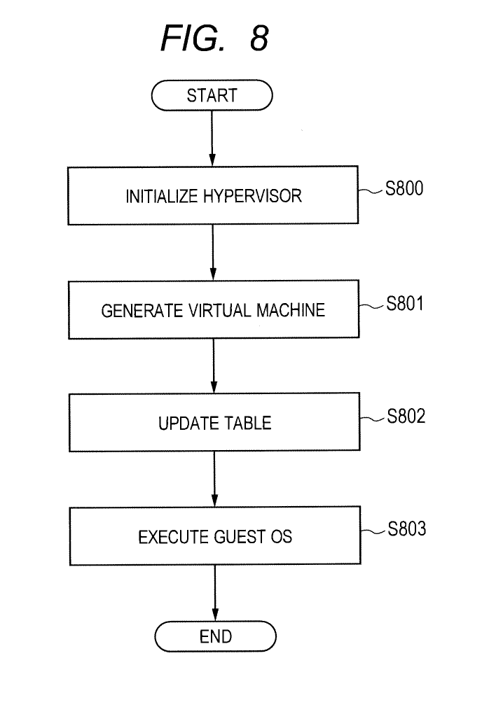

FIG. 8 is a flowchart explaining a processing that the hypervisor 101 in the first embodiment of the present invention performs at the time of starting.

When the administrator or the like turns on the power supply of the physical server 100, the processing will be started by the CPU 104 loading the hypervisor 101 to the memory 105 and executing it.

The hypervisor 101 initializes the hypervisor 101 itself and the physical server 100 (Step S800). At this time, the hypervisor 101 also validates the IOV function of the NIC 117.

In a processing of Step S800, further, the following processings are performed.

The hypervisor 101 instructs to generate the VF 206 to the PF 204 of the each NIC 117. Furthermore, the hypervisor 101 creates an entry of the generated VF 206 in the adapter allocation table 208, stores identifiers corresponding to the PF ID 400 and the VF ID 401 of the each entry, and stores “unallocated” in the virtual machine ID 402 of all the entries to initialize them.

Moreover, the hypervisor 101 initializes each table by putting the capping table 201, the QoS group table 202, and the capacity table 203 in un-inputted states.

Based on an input from the console 111 or an allocation instruction at the time of last time starting, the hypervisor 101 generates the virtual machine 102 and allocates the VF 206 to the virtual machine 102 (Step S801). At this time, the hypervisor 101 retrieves an entry corresponding to the allocated VF 206 by referring to the adapter allocation table 208, and stores the identifier of the appropriate virtual machine 102 in the virtual machine ID 402 of the entry.

Incidentally, in Step S801, the hypervisor 101 generates the virtual machine group, and sets the guaranteed bandwidth and the bandwidth in use for the virtual machine group.

The hypervisor 101 updates each table after generating the virtual machines 102 (Step S802). Then, the throughput analysis unit 200 starts a bandwidth control processing.

The following processings are performed in the processing of Step S802.

The hypervisor 101 generates an entry corresponding to the VF 206 allocated to the virtual machine 102 in the capping table 201, and stores the identifier of the VF 206 corresponding to the VF ID 502 of each generated entry. Moreover, the hypervisor 101 stores the identifier of the NIC 117 to which the VF 206 is allocated in the NIC ID 501 of the each generated entry, and stores the identifier of the virtual machine group to which the virtual machine 102 having allocated the VF 206 belongs in the Group ID 503. Furthermore, the hypervisor 101 stores the capping value specified by the input or allocation instruction in the capping value 505 of each entry.

The hypervisor 101 generates an entry corresponding to the generated virtual machine group in the QoS group table 202, and stores an identifier of the virtual machine group in the Group ID 601 of the each generated entry. Moreover, the hypervisor 101 stores in the guaranteed bandwidth 602 and the total bandwidth in use 603 the guaranteed bandwidth set in the corresponding virtual machine group and the total bandwidth in use in the virtual machine group. Incidentally, at the time of initialization, the total bandwidth in use 603 may remain as a blank.

Furthermore, the hypervisor 101 generates an entry corresponding to the NIC 117 that the physical server 100 has in the capacity table 203, and stores an identifier of the NIC corresponding to the NIC ID 701 of the generated entry corresponding to the NIC 117. The hypervisor 101 stores the maximum bandwidth of the NIC 117 corresponding to the entry and the total bandwidth in use that is used by the virtual machine 102 in the maximum bandwidth 702 and the total bandwidth in use 703 of the generated entry. Incidentally, at the time of initialization, the total bandwidth in use 703 may remain as a blank.

Moreover, the throughput analysis unit 200 issues a command to set up the capping value of each VF 206 based on a value of the capping value 505 of the capping table 201.

Incidentally, regarding each table updated in the processing of Step S802, it is also possible to divert information set up last time by storing it in the disk device 113 etc. in advance and reading it from the disk device 113 etc. at the time of starting the hypervisor 101.

The hypervisor 101 makes the generated virtual machine 102 operate, and performs a guest OS 103 and an application on the virtual machine 102 (Step S803).

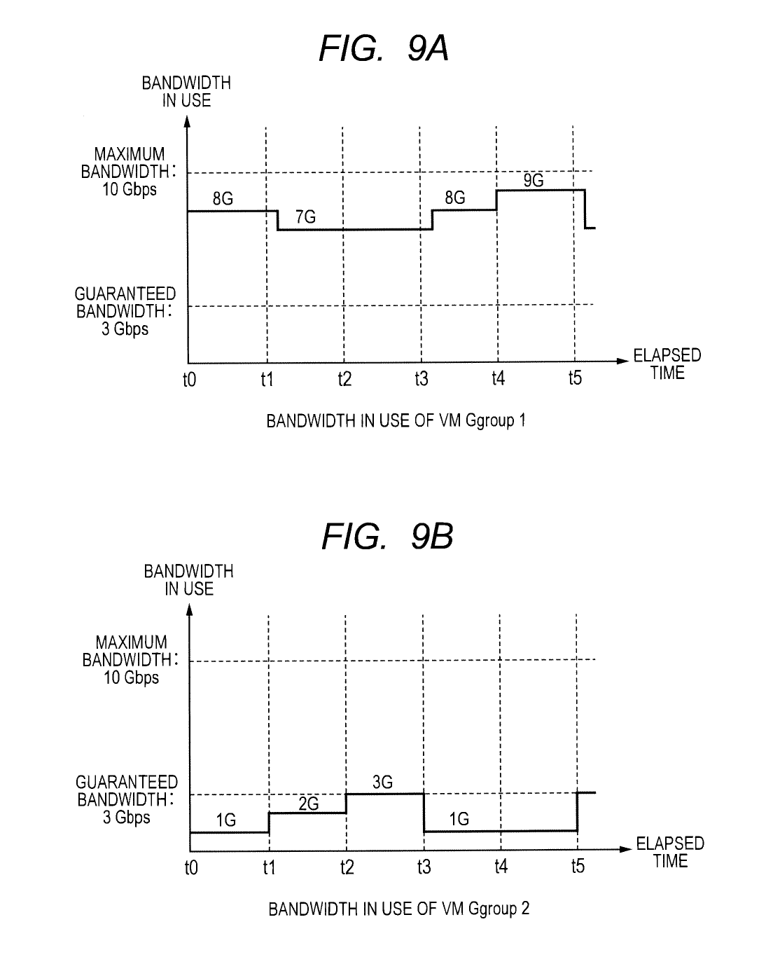

FIG. 9 is an explanatory drawing showing an outline of the bandwidth control processing that the throughput analysis unit 200 in the first embodiment of the present invention performs.

Among graphs shown in FIG. 9, FIG. 9A is a graph showing the bandwidth in use of the virtual machine group 1 and FIG. 9B is a graph showing the bandwidth in use of the virtual machine group 2. Incidentally, a horizontal axis represents time and a vertical axis represents bandwidth in use. Moreover, it is assumed that the virtual machine group 1 and the virtual machine group 2 use the same PF driver 209 (the NIC 117), and the maximum bandwidth of the NIC 117 is 10 Gbps. Moreover, the guaranteed bandwidth of the each virtual machine group is assumed to be set to 3 Gbps.

At time t0, the bandwidth in use of the virtual machine group 1 is 8 Gbps, and the bandwidth in use of the virtual machine group 2 is 1 Gbps. At this time, the total bandwidth in use in the NIC 117 is 9 Gbps, and a free bandwidth is 1 Gbps.

In this embodiment, when the total bandwidth in use of the NIC 117 is not identical to the maximum bandwidth, a control of the bandwidth is not performed. Therefore, at time t0, since there is a free bandwidth in the NIC 117, the control of the bandwidth is not performed.

At time t1, although the bandwidth in use of the virtual machine group 1 has not changed, the bandwidth in use of the virtual machine group 2 has increased to 2 Gbps. At this time, the total bandwidth in use in the NIC 117 becomes 10 Gbps, which is a state of using its bandwidth to the maximum bandwidth. Therefore, in the throughput analysis unit 200, the bandwidth control is performed.

Specifically, the throughput analysis unit 200 analyzes whether the virtual machine group 1 and the virtual machine group 2 have successfully secured the bandwidth more than or equal to the guaranteed bandwidth. As a result of the analysis, the throughput analysis unit 200 detects that the virtual machine group 2 has not been able to secure the guaranteed bandwidth, and lowers the capping value of the virtual machines 102 included in the virtual machine group 1 that secures the bandwidth more than or equal to the guaranteed bandwidth.

The above processing makes it possible to secure a free bandwidth available to the virtual machine group 2, and to secure the guaranteed bandwidth by allocating the free bandwidth.

In the example shown in FIG. 9, the throughput analysis unit 200 has secured a free bandwidth in use equal to 1 Gbps by lowering the total bandwidth in use of the virtual machine group 1 by 1 Gbps.

At time t2, although the bandwidth of the virtual machine group 1 in use has not changed, the bandwidth in use of the virtual machine group 2 has increased to 3 Gbps. At this time, the total bandwidth in use of the NIC 117 becomes 10 Gbps, being in a state of using its bandwidth to the maximum bandwidth. However, since both the virtual machine group 1 and the virtual machine group 2 have secured the guaranteed bandwidth in this case, the bandwidth control is not performed.

At time t3, the virtual machine group 2 is in a state where its bandwidth in use descended to 1 Gbps. At this time, although the bandwidth of the virtual machine group 2 in use is smaller than the guaranteed bandwidth, since there is a free bandwidth in the bandwidth of the NIC 117, the bandwidth control is not performed. Moreover, in the virtual machine group 1, since there is a free bandwidth and the virtual machine group 1 is in a stable state, the capping value of the virtual machines 102 included in the virtual machine group 1 is raised.

At time t4, the bandwidth in use of the virtual machine group 1 has increased to 9 Gbps. At this time, the virtual machine group 1 is in a state of using its bandwidth to the maximum bandwidth, and since the guaranteed bandwidth of the virtual machine group 2 is not securable, the throughput analysis unit 200 lowers the capping value of the virtual machine group 1 again.

The above-described processing enables the guaranteed bandwidth of the virtual machine group to be secured even when the bandwidth is used to the maximum bandwidth of the NIC 117. Hereafter, details of the bandwidth control processing will be explained.

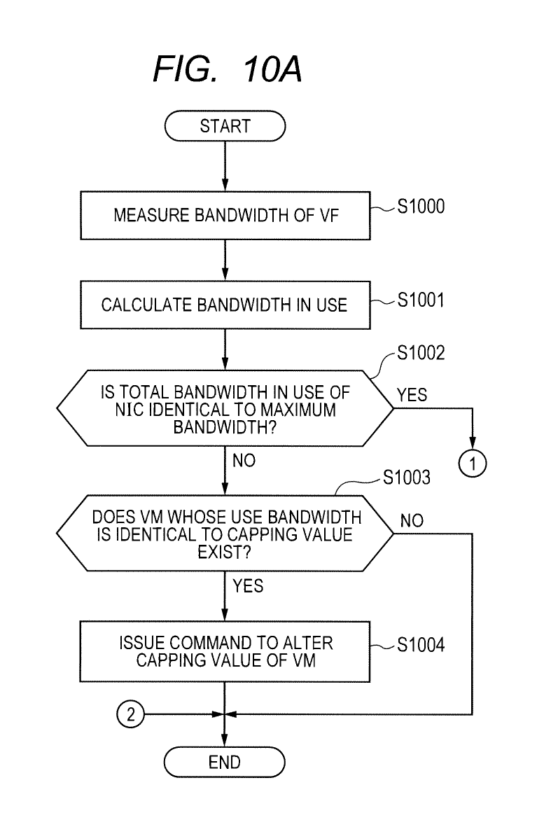

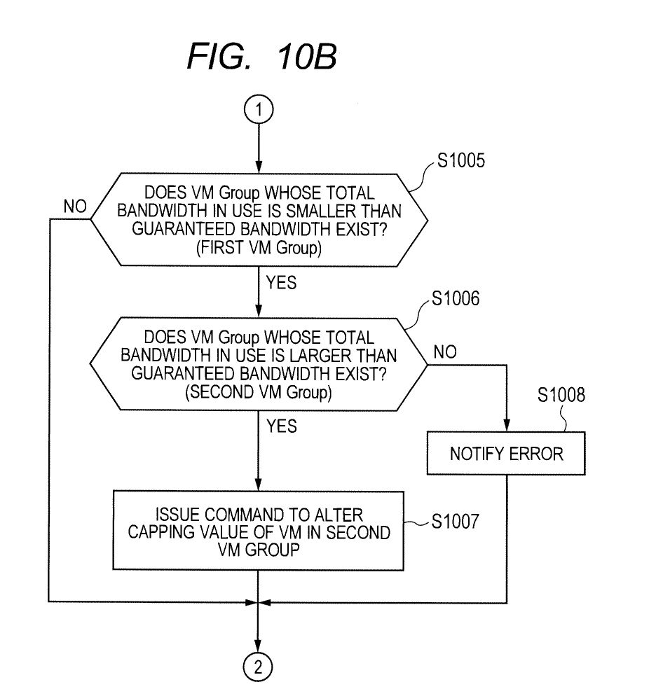

FIG. 10A and FIG. 10B are flowcharts explaining details of the bandwidth control processing in the first embodiment of the present invention.

The throughput analysis unit 200 measures periodically the bandwidth in use of the VF 206 allocated to the virtual machine 102 (Step S1000).

The throughput analysis unit 200 calculates the total bandwidth in use of each NIC 117 and the total bandwidth in use of each virtual machine group using a measured value of the bandwidth in use (Step S1001).

At this time, the throughput analysis unit 200 stores the measured bandwidth in use of the each VF 206 in the capping table 201, stores the calculated total bandwidth in use of the each virtual machine group in the QoS group table 202, and stores the calculated total bandwidth in use of the each NIC 117 in the capacity table 203.

Next, the throughput analysis unit 200 performs processings of Step S1002 to Step 1008 for every NIC 117. Hereafter, the NIC 117 that is to be processed is also described as an object NIC 117.

The throughput analysis unit 200 determines whether the total bandwidth in use of the object NIC 117 is identical to the maximum bandwidth (Step S1002).

Specifically, the throughput analysis unit 200 refers to the entry corresponding to the object NIC 117 of the capacity table 203, compares the maximum bandwidth 702 and the total bandwidth in use 703 of the entry, and determines whether a value of the total bandwidth in use 703 is identical to a value of the maximum bandwidth 702. Hereafter, the NIC 117 whose bandwidth is used up to the maximum bandwidth is also described as a first NIC 117. Moreover, the NIC 117 whose bandwidth is not used up to the maximum bandwidth is also described as a second NIC 117.

When it is determined that the object NIC 117 is not the first NIC 117, namely it is determined that the object NIC 117 is the second NIC 117, the throughput analysis unit 200 determines whether there exists the virtual machine 102 whose bandwidth in use is identical to the capping value among the virtual machines 102 included in the virtual machine group that uses a resource of the second NIC 117 (Step S1003).

Specifically, the throughput analysis unit 200 refers to the entry corresponding to the second NIC 117 of the capping table 201, compares the bandwidth in use 504 and the capping value 505 of the entry, and determines whether there exists an entry whose value of the bandwidth in use 504 is identical to a value of the capping value 505.

When it is determined that there does not exist the virtual machine 102 whose bandwidth in use is identical to the capping value, the throughput analysis unit 200 ends the processing.

When it is determined that there exists the virtual machine 102 whose bandwidth in use is identical to a capping value, the throughput analysis unit 200 issues an alteration command to the capping function 207 in order to increase the capping value of the virtual machine 102 (Step S1004), and ends the processing.

For example, when raising the capping value, a method is conceivable where when the capping value of the virtual machine 102 has been lowered in the last processing, the capping value is raised only by an amount of a lowered bandwidth. Moreover, a value of a bandwidth to be added may be set in advance.

Incidentally, the command to alter the capping value contains at least an identifier of the object virtual machine 102 and a value of an additional bandwidth.

When it is determined that the object NIC 117 is the first NIC 117 in Step S1002, the throughput analysis unit 200 determines whether there exists a virtual machine whose total bandwidth in use is smaller than the guaranteed bandwidth among the virtual machine groups that use a resource of the first NIC 117 (Step S1005). Specifically, the following processings are performed.

The throughput analysis unit 200 specifies the virtual machine group that uses the resource of the first NIC 117 referring to the capping table 201. Furthermore, the throughput analysis unit 200 refers to an entry of an object virtual machine group of the QoS group table 202, compares the guaranteed bandwidth 602 and the total bandwidth in use 603, and determines whether there exists an entry whose value of the total bandwidth in use 603 is smaller than a value of the guaranteed bandwidth 602.

Hereafter, the virtual machine group that satisfies the condition of Step S1005 is described as a first virtual machine group.

When it is determined that the first virtual machine group does not exist, the throughput analysis unit 200 ends the processing, without performing the bandwidth control particularly.

When it is determined that the first virtual machine group exists, the throughput analysis unit 200 determines whether there exists a virtual machine group whose bandwidth in use is larger than the guaranteed bandwidth among the virtual machine groups that use the resource of the first NIC 117 (Step S1006). Hereafter, the virtual machine group that satisfies a condition of Step S1006 is described as a second virtual machine group.

Specifically, the throughput analysis unit 200 refers to the entry of the object virtual machine group of the QoS group table 202, compares the guaranteed bandwidth 602 and the total bandwidth in use 603, and determines whether there exists an entry whose value of the total bandwidth in use 603 is larger than a value of the guaranteed bandwidth 602.

When it is determined that the second virtual machine group does not exist, since the throughput analysis unit 200 cannot secure the free bandwidth to be allocated to the first virtual machine group, it notifies an error (Step S1008) and ends the processing.

When it is determined that the second virtual machine group exists, the throughput analysis unit 200 issues the alteration command to the capping function 207 in order to decrease the capping value of the virtual machines 102 in the second virtual machine group (Step S1007), and ends the processing.

For example, when decreasing the capping value, a method is conceivable that decreases the capping value of the virtual machines 102 included in the second virtual machine group by a bandwidth that is short to the guaranteed bandwidth of the first virtual machine group. Moreover, a value of the bandwidth that is decreased may be set in advance.

Incidentally, the command to alter the capping value contains at least an identifier of the object virtual machine group and the value of the reduced bandwidth.

Moreover, if a bandwidth necessary to secure the guaranteed bandwidth of the first server group is still short even when the capping value of the virtual machines 102 in the second virtual machine group is decreased, the throughput analysis unit 200 may notify an error.

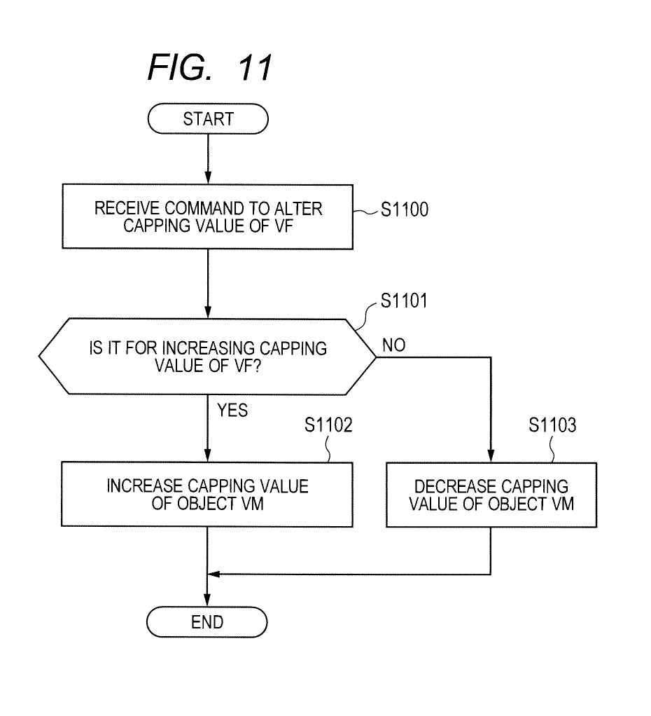

FIG. 11 is a flowchart explaining a processing performed when the capping function 207 in the first embodiment of the present invention receives the command to alter the capping value.

Upon reception of the command to alter the capping value of the virtual machine 102 (Step S1100), the capping function 207 determines whether the alteration command is a command to raise the capping value (Step S1101).

When it is determined that the received alteration command is a command to raise the capping value, the capping function 207 raises the capping value of the VF 206 allocated to the object virtual machine 102 based on the received alteration command (Step S1102), and ends the processing.

Incidentally, the identifier of the object virtual machine 102 and the value of the additional bandwidth are contained in the received alteration command. Therefore, the capping function 207 can specify the object virtual machine 102 based on the information contained in the alteration command, and can raise the capping value of the VF 206 allocated to the virtual machine 102.

When it is determined that the received alteration command is not the command to raise the capping value, i.e., it is a command to lower the capping value, the capping function 207 lowers the capping value of the VF 206 allocated to the virtual machine 102 included in the object virtual machine group (Step S1103), and ends the processing.

For example, a method whereby the capping value of the VF 206 allocated to a predetermined number of the virtual machines 102 in the object virtual machine group is lowered by a fixed value etc. are conceivable. Incidentally, the present invention is not limited to the method of lowering the capping value.

That the hypervisor 101 performs the above-described bandwidth control processing makes it possible to ensure the bandwidth of each virtual machine group. Although the above-described bandwidth control processing was explained taking the guaranteed bandwidth of the virtual machine group as an example, the bandwidth of an individual virtual machine 102 can also be secured by applying the same bandwidth control processing thereto. For example, the same processing is applicable by handling one virtual machine 102 as one virtual machine group.

Moreover, it is also possible to set a precedence to the virtual machine group by adjusting a setting value of the guaranteed bandwidth according to a use application. In the above-described bandwidth control processing, when the second virtual machine group did not exist, the throughput analysis unit 200 notified the error, but a measure against a shortage of the guaranteed bandwidth is possible by using the above-mentioned precedence.

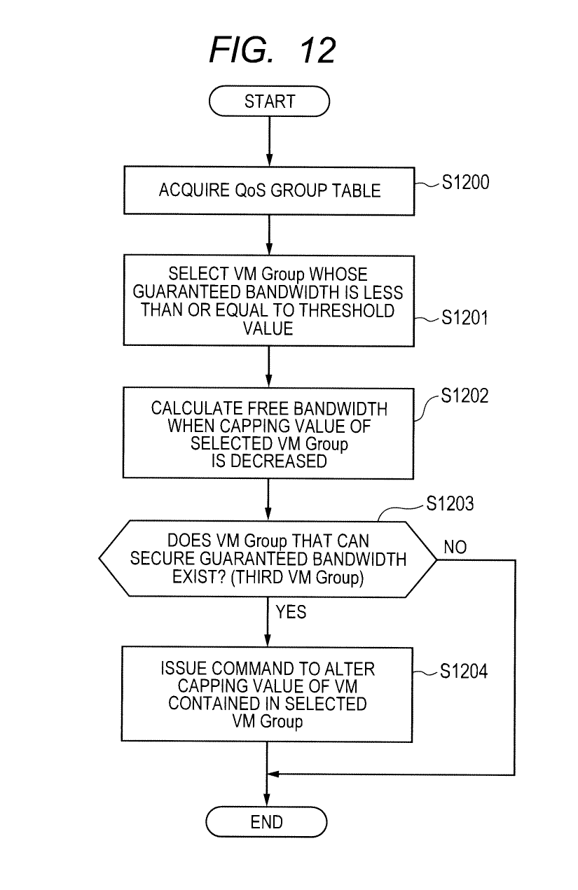

For example, if the guaranteed bandwidth set to the virtual machine group is considered the precedence of the bandwidth in use, as long as the second virtual machine group does not exist, the throughput analysis unit 200 will be able to guarantee the bandwidth of the virtual machine group whose guaranteed bandwidth is large (whose precedence is high) by lowering the capping value of the virtual machines 102 included in the virtual machine group whose guaranteed bandwidth is small (whose precedence is low). Hereafter, details of the processing will be explained using FIG. 12.

FIG. 12 is a flowchart explaining a modification of the bandwidth control processing in the first embodiment of the present invention. Incidentally, since processings of Step S1000 to Step S1007 are the same as those of the first embodiment, their explanations are omitted. Here, the modification of the processing in Step S1008 will be explained.

When it is determined that the second virtual machine group does not exist in Step S1006, the throughput analysis unit 200 acquires the QoS group table 202 and extracts the guaranteed bandwidth set in each virtual machine group that uses the resource of the first NIC 117 (Step S1200).

Here, it is assumed that a different guaranteed bandwidth is set in each virtual machine group, and the size of the guaranteed bandwidth is equivalent to the precedence. This enables the throughput analysis unit 200 to determine which virtual machine group's bandwidth should be secured preferentially.

Next, the throughput analysis unit 200 selects the virtual machine group whose guaranteed bandwidth being set is less than or equal to a predetermined threshold (Step S1201). Incidentally, the predetermined threshold may be set in advance, or the guaranteed bandwidth set to the virtual machine group that has multiple virtual machines 102 each with a low use frequency from the use situation of the bandwidth may be set as the threshold.

The throughput analysis unit 200 calculates a free bandwidth that arises by lowering the capping value of the predetermined number of virtual machines 102 included in the selected virtual machine group by a predetermined value (Step S1202). Incidentally, a range of reduction of the capping value shall be one that is set in advance.

The throughput analysis unit 200 determines whether there exists a virtual machine group that can secure the guaranteed bandwidth among the virtual machine groups whose precedence is high using the calculated free bandwidth (Step S1203). Hereafter, the virtual machine group that satisfies a condition of Step S1203 is described as a third virtual machine group.

When it is determined that the third virtual machine group does not exist, the throughput analysis unit 200 ends the processing.

When it is determined that the third virtual machine group exists, the throughput analysis unit 200 issues the alteration command to lower the capping value of the virtual machines 102 included in the selected virtual machine group (Step S1204), and ends the processing.

By this, the bandwidth can be guaranteed sequentially from the virtual machine group whose guaranteed bandwidth is large (precedence is high).

According to the first embodiment, even in the state where the whole of the maximum bandwidth of the NIC 117 is used, the guaranteed bandwidth is realizable by controlling the capping value set to the virtual machine group or the virtual machine 102.

Moreover, since the hypervisor 101 analyzes the bandwidth in use and the NIC having a SR-IOV function performs the bandwidth control, it becomes possible for the physical server 100 not to waste a CPU resource and to support the wide bandwidth. In this embodiment, the NIC having the existing SR-IOV function can be used as it is without altering its configuration.

Furthermore, by setting the guaranteed bandwidth of a different value for each virtual machine group according to a use of the virtual machine 102, it becomes possible to perform the bandwidth control in which the virtual machine groups are given respective precedences.

### Second Embodiment

In a second embodiment, a respect that the NIC 117 not having the SR-IOV function is used is different. In this embodiment, the hypervisor 101 allocates a VNIC 1301 obtained by virtualizing the NIC 117 to the virtual machine 102, and the NIC 117 controls a bandwidth of the VNIC 1301. Hereafter, a difference from the first embodiment will be focused and explained.

Since a configuration of a computer system is identical to that of the first embodiment, its explanation is omitted.

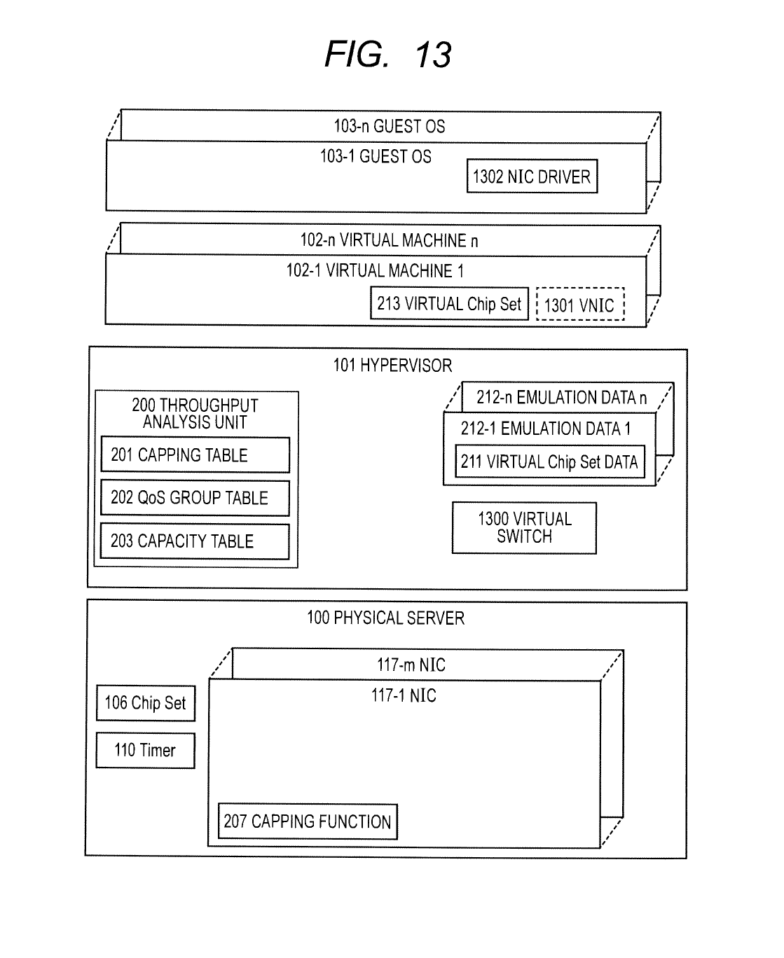

FIG. 13 is a block diagram explaining details of a configuration of the physical server 100 in the second embodiment of the present invention. Since any component that is attached the same symbol as that of the first embodiment is the same component, its explanation is omitted.

In the second embodiment, the hypervisor 101 allocates an arbitrary virtual NIC (VNIC) 1301 to the virtual machine 102 in place of the VF 206 in a shared manner or exclusively.

When the VNIC 1301 is allocated in a shared manner, the virtual machine 102 communicates with the NIC 117 via the virtual switch 1300; when the VNIC 1301 is allocated exclusively, the virtual machine 102 communicates with the NIC 117 directly.

In the second embodiment, the virtual machine 102 includes the VNIC 1301 allocated in a shared manner besides the virtual Chip Set 213 provided by the hypervisor 101. Moreover, the guest OS 103 has an NIC driver 1302 in place of the VF driver 210.

Moreover, the NIC 117 differs from the first embodiment in that it does not contain a configuration corresponding to the SR-IOV function. Since the hypervisor 101 does not need to manage allocation of the VF 206, it does not hold the adapter allocation table 208, and since it does not need to operate the VF 206, it does not hold the PF driver 209.

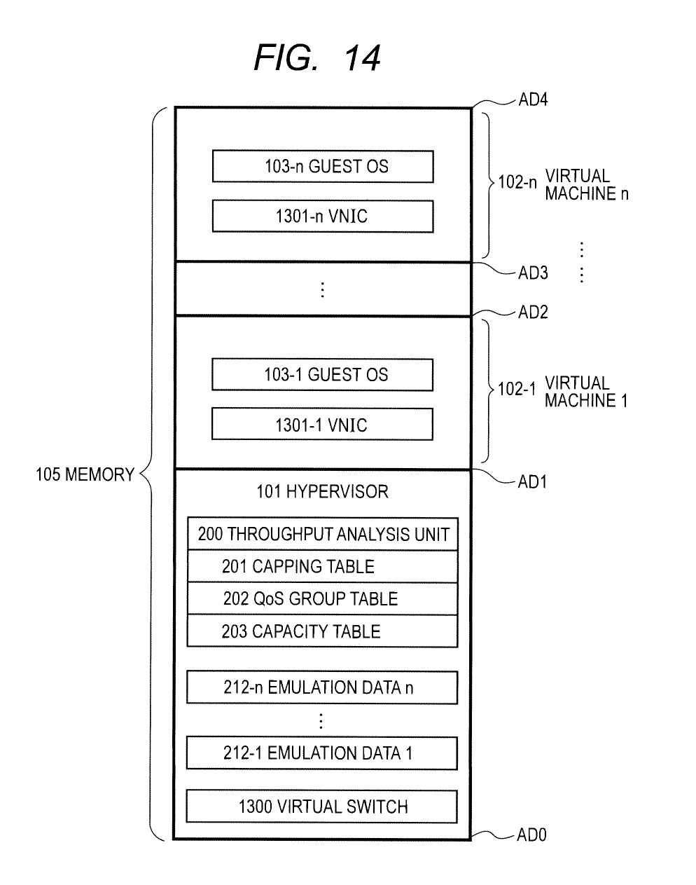

FIG. 14 is an explanatory drawing showing an example of a position of a storage area of the memory 105 in the second embodiment of the present invention.

The guest OS 103 and the VNIC 1301 are stored in the storage area allocated to the each virtual machine 102. In the storage area allocated to the hypervisor 101, the virtual switch 1300, the emulation data 212, the throughput analysis unit 200, the capping table 201, the QoS group table 202, and the capacity table 203 are stored.

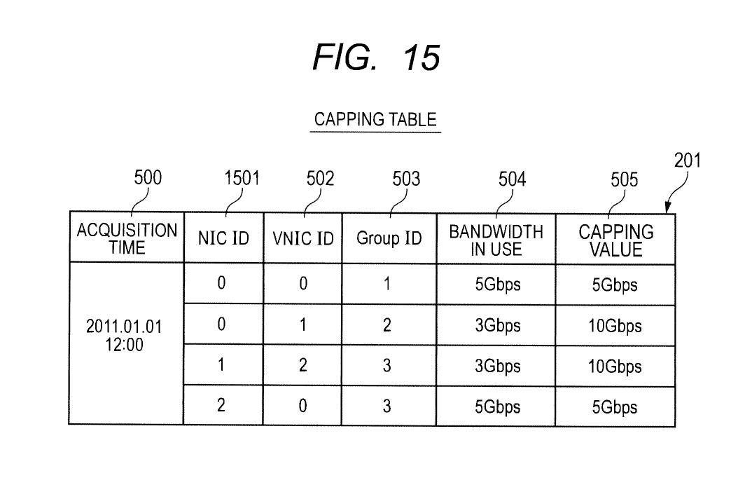

FIG. 15 is an explanatory drawing showing one example of the capping table 201 in the second embodiment of the present invention.

The capping table 201 of the second embodiment contains the VNIC ID 1501 in place of the VF ID 502. The VNIC ID 1501 stores an identifier of the VNIC 1301. Therefore, the capping table 201 of the second embodiment stores the bandwidth in use of the VNIC 1301 allocated to the virtual machine 102 and the capping value.

Moreover, a connection relation of the VNIC ID 1501 is known from the NIC ID 501, the Group ID 503, and the VNIC 1301.

Although the processing when the hypervisor 101 is starting is almost identical to that of the first embodiment, what are different therefrom are that the CPU 104 invalidates the IOV function in Step S800 and that the hypervisor 101 allocates the VNIC 1301 to the virtual machine 102 in Step S801.

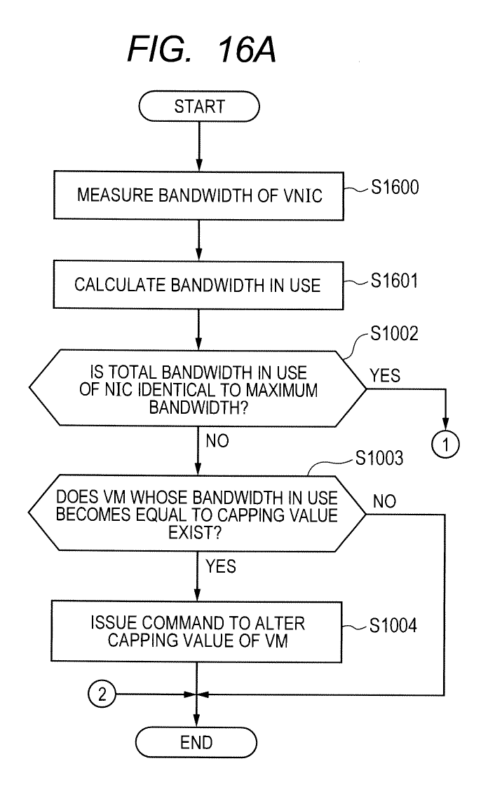

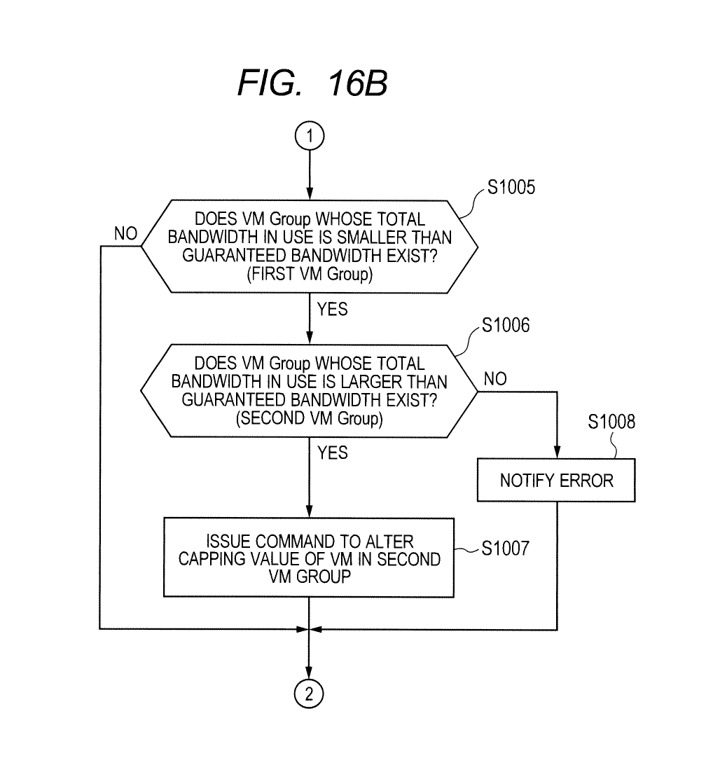

FIG. 16A and FIG. 16B are flowcharts explaining details of a bandwidth control processing in the second embodiment of the present invention.

In the bandwidth control processing in the second embodiment, a monitor object becomes the bandwidth in use of the VNIC 1301 of the virtual machine 102. Moreover, regarding a setting of the capping value of the virtual machine 102, it is also possible to control using the capping function 207 in the NIC 117 or a function of the VNIC provided by the hypervisor.

The throughput analysis unit 200 measures periodically the bandwidth in use of the VNIC 1301 allocated to the virtual machine 102 (Step S1600).

The throughput analysis unit 200 calculates the total bandwidth in use of each NIC 117 and the total bandwidth in use of each virtual machine group using the measured value of the bandwidth in use (Step S1601).

At this time, the throughput analysis unit 200 stores the measured bandwidth in use of every VNIC 1301 in the capping table 201, stores the calculated total bandwidth in use of every virtual machine group in the QoS group table 202, and stores the calculated total bandwidth in use of every NIC 117 in the capacity table 203.

Since the processings of Step 1002 to Step 1008 are identical to those of the first embodiment except for a point that an object on which the bandwidth control is performed is the VNIC 1301, their explanations are omitted.

According to the second embodiment, even in the computer system using the NIC 117 that has no SR-IOV function, it is possible to realize the bandwidth guarantee to the virtual machine group or the virtual machine 102. Moreover, since the NIC 117 performs the bandwidth control, the CPU resource of the physical server 100 is not wasted, and supporting the wide bandwidth becomes also possible.

### Third Embodiment

In a third embodiment, the bandwidth control is performed by putting a delay in the interrupt processing at the time of I/O communication. Hereafter, a difference from the first embodiment will be focused and explained.

Since a configuration of a computer system is identical to that of the first embodiment, its explanation is omitted.

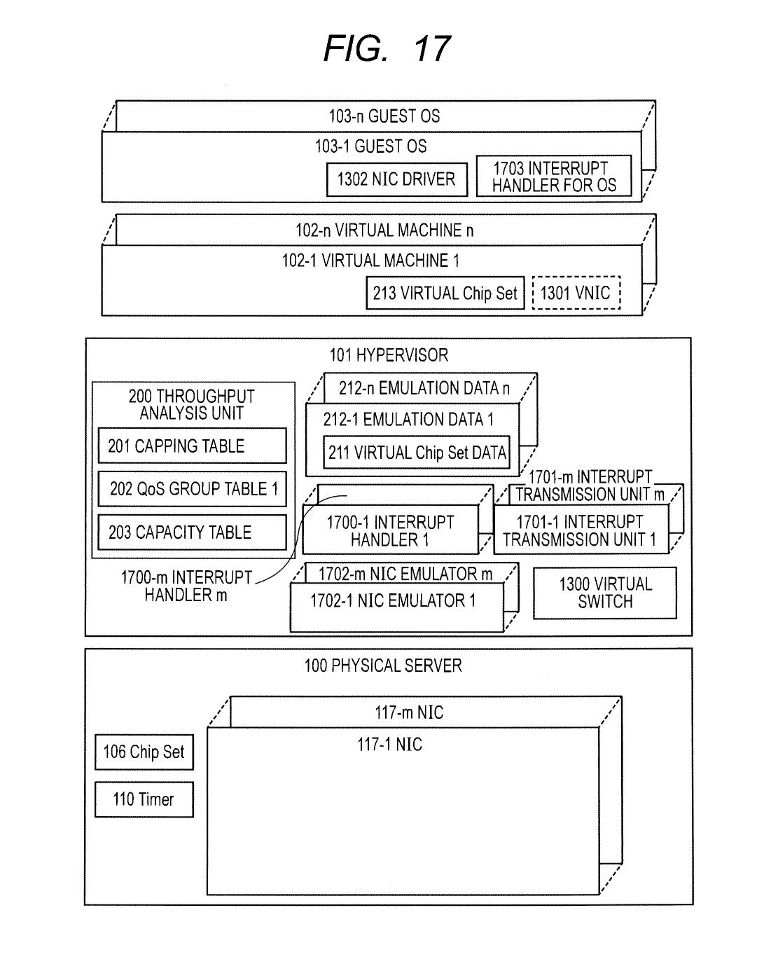

FIG. 17 is a block diagram explaining details of a configuration of the physical server 100 in the third embodiment of the present invention.

In the third embodiment, the NIC 117 does not hold the SR-IOV function and the function of capping. Therefore, the hypervisor 101 allocates the VNIC obtained by virtualizing the NIC 117 to the virtual machine 102.

The hypervisor 101 of the third embodiment includes interrupt handlers 1700-1 to 1700-m, interrupt transmission units 1701-1 to 1701-m, NIC emulators 1702-1 to 1702-m, and a virtual switch 1300 afresh. On the other hand, the hypervisor 101 of the third embodiment does not hold the adapter allocation table 208 because it does not need to manage allocation of the VF 206, and does not hold the PF driver 209 because it does not need to operate the VF 206.

The interrupt handlers 1700-1 to 1700-m are modules each for accepting data received from the NIC 117. The interrupt transmission unit 1701 is a module for transmitting the received data to the virtual machine 102. The NIC emulator 1702 is a module for receiving data that the virtual machine 102 transmitted.

When receiving the data from the NIC 117, the interrupt handler 1700 issues a command to interrupt to an interrupt handler 1703 for OS of the guest OS 103 on the virtual machine 102 to the throughput analysis unit 200.

The throughput analysis unit 200 sets a delay according to the capping value stored in the capping table 201. Incidentally, in the setting of the delay, the Timer 110 that the physical server 100 has may be used.

The interrupt transmission unit 1701 issues a command to interrupt the interrupt handler 1703 for OS of the guest OS 103 on the virtual machine 102.

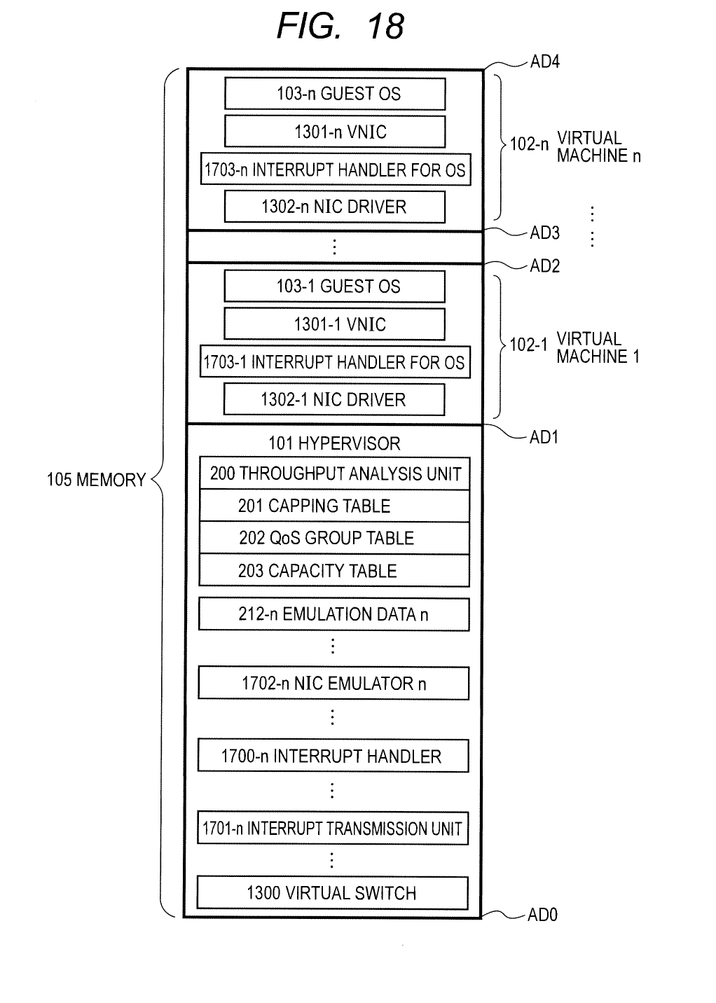

FIG. 18 is an explanatory drawing showing one example of a storage area of the memory 105 in the third embodiment of the present invention.

The guest OS 103, the VNIC 1301, the NIC driver 1302, and the interrupt handler 1703 for OS are stored in the storage area allocated to each virtual machine 102.

In the storage area allocated to the hypervisor 101, the emulation data 212, the throughput analysis unit 200, the QoS group table 202, the capacity table 203, the NIC emulator 1702, the interrupt handler 1700, the interrupt transmission unit 1701, and the virtual switch 1300 are stored.

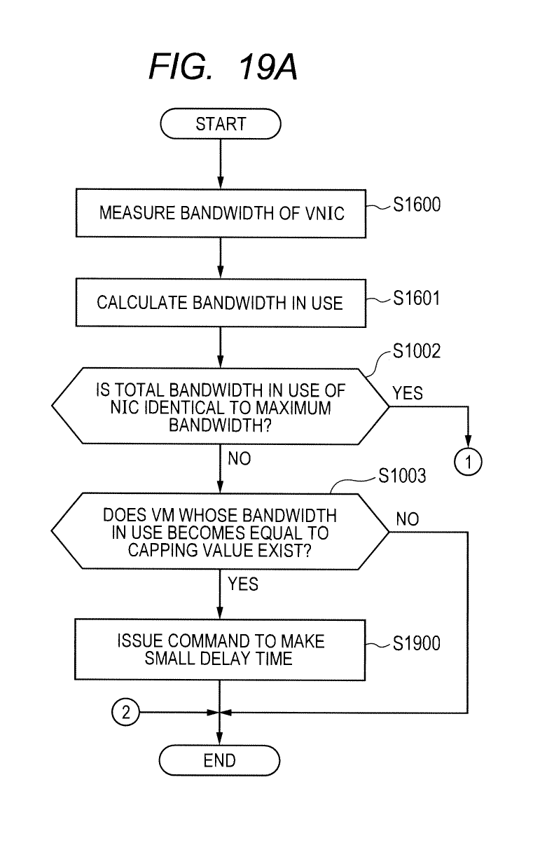

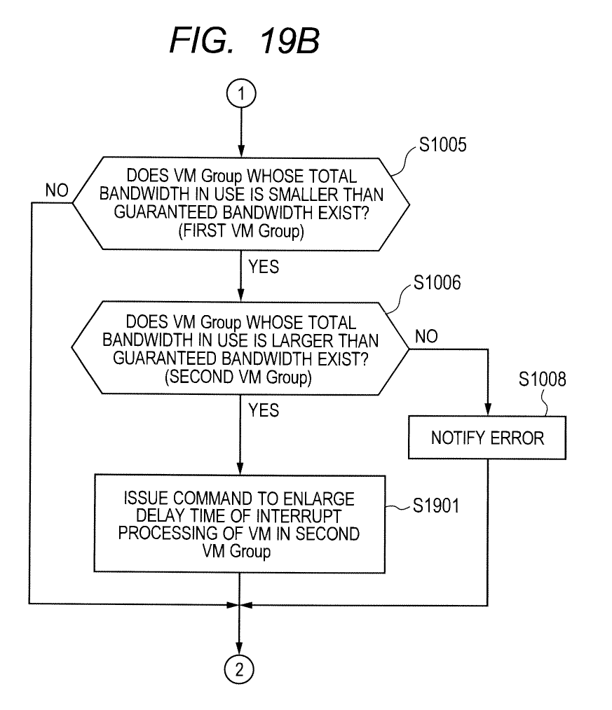

FIG. 19A and FIG. 19B are flowcharts explaining details of a bandwidth control processing in the third embodiment of the present invention.

In the bandwidth control processing in the third embodiment, the bandwidth is controlled by setting a delay in the interrupt processing to the virtual machine 102.

For example, when raising the capping value, the throughput analysis unit 200 raises a transmission speed of the virtual machine 102 by decreasing a delay time in the interrupt processing to the virtual machine 102, and increases the bandwidth in use of the virtual machine 102. On the other hand, when lowering the capping value, the transmission speed of the virtual machine 102 is lowered by increasing the delay time that is put into the interrupt processing to the virtual machine 102, and the bandwidth in use of the virtual machine 102 is lowered. Since Step S1600 is the same processing as that of the second embodiment, its explanation is omitted. Since Steps S1001 to Step S1003 are the same processings as those of the first embodiment, their explanations are omitted.

In Step S1003, when it is determined that there exists the virtual machine 102 whose bandwidth in use is identical to the capping value, the throughput analysis unit 200 issues a command to make small the delay time in the interrupt processing to the virtual machine 102 in order to raise the capping value of the virtual machine 102 (Step S1900), and ends the processing. Incidentally, the command is outputted to the Timer 110 and the Timer 110 alters the delay time in the interrupt processing.

When it is determined that there exists the second virtual machine group in Step S1006, the throughput analysis unit 200 issues a command to enlarge the delay time in the interrupt processing to the virtual machine 102 in order to lower the capping value of the virtual machines 102 included in the second virtual machine group (Step S1901), and ends the processing. Incidentally, the command is outputted to the Timer 110, and the Timer 110 alters the delay time in the interrupt processing.

According to the third embodiment, it is possible to realize the guaranteed bandwidth by controlling the delay time in the interrupt processing to the virtual machine group or the virtual machine 102. Moreover, for the bandwidth control, only the delay is set up using the Timer 110, and therefore the CPU resource of the physical server 100 is not wasted and supporting the wide bandwidth becomes also possible.

Moreover, although the embodiments of the present invention were explained, a technical range of the present invention is not limited to the range described in the above-mentioned embodiments. Although the invention made by the present inventors was concretely explained based on the above-mentioned embodiments, it goes without saying that various alterations and modifications can be added to it without deviating from the gist thereof. Therefore, naturally a form to which such an alteration or improvement is added is also included in the technical scope of the present invention.

What is claimed is:

1. A computer comprising a processor, memory connected to the processor, and one or more network interfaces for communicating with an other device,
wherein the computer has a virtualization management unit that divides a resource of the computer to generate one or more virtual computers and manages the generated virtual computers and a bandwidth control unit for controlling a bandwidth in use in a virtual computer group comprised of the one or more virtual computers,
wherein the virtualization unit contains an analysis unit for managing the bandwidth in use of virtual network interfaces allocated to the virtual computers,
wherein when the bandwidth in use of the network interface is identical to a maximum bandwidth that is an upper limit of the bandwidth in use of the network interface, the analysis unit holds guaranteed bandwidth information for managing a guaranteed bandwidth that is a bandwidth that should be secured in the virtual computer group,
wherein the analysis unit
measures the bandwidth in use of the each virtual computer,
retrieves a first network interface whose bandwidth in use is identical to the maximum bandwidth of the network interface,
determines whether there exists a first computer group whose bandwidth in use is smaller than the guaranteed bandwidth set in the virtual computer group among the virtual computer groups to each of which a resource of the first network interface is allocated based on the measurement result and by referring to the guaranteed bandwidth information, and
when it is determined that the first virtual computer group exists, retrieves a second virtual computer group whose bandwidth in use is larger than the guaranteed bandwidth set in the virtual computer group among the virtual computer groups to each of which the resource of the first network interface is allocated based on the measurement result and by referring to the guaranteed bandwidth information and commands the bandwidth control unit to control the bandwidth of the second virtual computer group, and
wherein the bandwidth control unit secures a free bandwidth just equal to a shortage of the guaranteed bandwidth of the first virtual computer group by controlling the bandwidth of the retrieved second virtual computer group.

2. The computer according to claim 1,
wherein a free bandwidth that is available to the third virtual computer is secured by the analysis unit performing the following steps:
retrieving a second network interface whose bandwidth in use is smaller than the maximum bandwidth of the network interface;
determining whether there exists a third virtual computer group whose bandwidth in use is identical to the guaranteed bandwidth set in the virtual computer group among the virtual computer groups to each of which a resource of the second network interface is allocated based on the measurement result and by referring to the guaranteed bandwidth information; and
when it is determined that there exists the third virtual computer group, securing a free bandwidth available to the third virtual computer group by controlling a bandwidth of a predetermined number of the virtual computers included in the third virtual computer group.

3. The computer according to claim 1,
wherein a precedence in which the bandwidth in use of the virtual machine group is secured is set in the virtual machine group, and
wherein when the second virtual machine group does not exist, a free bandwidth is secured by controlling a bandwidth of a predetermined number of virtual computers included in the virtual computer group whose precedence is lower, and the secured free bandwidth is added to the virtual computer group whose precedence is higher.

4. The computer according to claim 3,
wherein the precedence is determined based on the size of the guaranteed bandwidth set in the virtual machine group.

5. The computer according to claim 1,
wherein the analysis unit holds capping information for managing a maximum bandwidth in use that is an upper limit of the bandwidth in use of the virtual computer, and
wherein when controlling the bandwidth of the predetermined number of virtual computers included in the virtual computer group, the bandwidth control unit secures a free bandwidth to be allocated to the other virtual computer groups by lowering the maximum bandwidth in use of the predetermined number of computers included in the virtual computer group, or secures the free bandwidth by raising the maximum bandwidth in use of the predetermined number of computers included in the virtual computer group.

6. The computer according to claim 1,
wherein when controlling the bandwidth of the predetermined number of virtual computers included in the virtual computer group, the bandwidth control unit secures a free bandwidth to be allocated to the other virtual computer groups by setting a delay time in a communication processing of the predetermined number of virtual computers included in the virtual computer group to be longer, or secures the free bandwidth to be allocated to the other virtual computer groups by setting the delay time in the communication processing of the predetermined number of virtual computers included in the virtual computer group to be shorter.

7. A bandwidth control method in a computer comprising a processor, memory connected to the processor, and one or more network interfaces for communicating with an other device,
wherein the computer has a virtualization management unit that divides a resource of the computer, generates one or more virtual machines, and manages the generated virtual machines and a bandwidth control unit for controlling a bandwidth in use in a virtual computer group comprised of the one or more virtual computers,
wherein the virtualization management unit contains an analysis unit for managing a bandwidth in use of virtual network interfaces allocated to the virtual computers,
wherein when the bandwidth of the network interface is identical to a maximum bandwidth that is an upper limit of the bandwidth in use of the network interface, the analysis unit holds guaranteed bandwidth information for managing a guaranteed bandwidth that is a bandwidth to be secured in the virtual computer group, and
wherein the method comprises:
a first step in which the analysis unit measures the bandwidth in use of the each virtual computer;
a second step in which the analysis unit retrieves a first network interface whose bandwidth in use is identical to the maximum bandwidth of the network interface based on the measurement result;
a third step in which the analysis unit determines whether there exists a first virtual computer group whose bandwidth in use is smaller than the guaranteed bandwidth set in the virtual computer group based on the measurement result and by referring to the guaranteed bandwidth information among the virtual computer groups to each of which the resource of the first network interface is allocated;
a fourth step in which when it is determined that there exists the first virtual computer group, the analysis unit retrieves a second virtual computer group whose bandwidth in use is larger than the guaranteed bandwidth set in the virtual computer group among the virtual computer groups to each of which the resource of the first network interface is allocated based on the measurement result and by referring to the guaranteed bandwidth information;
a fifth step in which the analysis unit commands the bandwidth control unit to control the bandwidth of the second virtual computer group; and
a sixth step in which the bandwidth control unit secures a free bandwidth just equal to a shortage of the guaranteed bandwidth of the first virtual computer group by controlling the bandwidth of the retrieved second virtual computer group.

8. The bandwidth control method according to claim 7, further comprising:
a step in which the analysis unit retrieves a second network interface whose bandwidth in use is smaller than the maximum bandwidth of the network interface;
a step in which the analysis unit determines whether there exists a third virtual computer group whose bandwidth in use is identical to the guaranteed bandwidth set in the virtual computer group among the virtual computer groups to each of which a resource of the second network is allocated based on the measurement result and by referring to the guaranteed bandwidth information; and
a step in which when it is determined that the third virtual computer group exists, the analysis unit secures a free bandwidth available to the third virtual computer group by controlling the bandwidth of a predetermined number of the virtual computers included in the third virtual computer group.

9. The bandwidth control method according to claim 7,
wherein a precedence in which the bandwidth of the virtual computer group is secured is set in the virtual computer group, and
wherein the fourth step includes the steps of:
when the second virtual computer group does not exists, securing the free bandwidth by controlling a bandwidth of a predetermined number of virtual computers included in the virtual computer group whose precedence is lower; and
adding the secured free bandwidth to the virtual computer group whose precedence is higher.

10. The bandwidth control method according to claim 9,
wherein the precedence is determined based on the size of the guaranteed bandwidth set in the virtual computer group.

11. The bandwidth control method according to claim 7,
wherein the analysis unit holds capping information for managing the maximum bandwidth in use that is the upper limit of the bandwidth in use of the virtual computer, and
wherein in a step in which a bandwidth of a predetermined number of virtual computers included in the virtual computer group is controlled,
the bandwidth control unit secures a free bandwidth to be allocated to the other virtual computer groups by lowering the maximum bandwidth in use of the predetermined number of virtual computers included in the virtual computer group or secures the free bandwidth of the virtual computer group by raising the maximum bandwidth in use of the predetermined number of virtual computers included in the virtual computer group.

12. The bandwidth control method according to claim 7,
wherein in a step where the bandwidth of the predetermined number of virtual computers included in the virtual computer group is controlled, the bandwidth control unit secures a free bandwidth to be allocated to the other virtual computer groups by setting a delay time in the communication processing of the predetermined number of virtual computers included in the virtual computer group to be longer or secures the free bandwidth to be allocated to the other virtual computer groups by setting the delay time in the communication processing of the predetermined number of virtual computers included in the virtual computer group to be shorter.
